(19) United States
(12) Patent Application Publication
(10) Pub. No.: US 2025/0378774 A1
(43) Pub. Date: Dec. 11, 2025

(54) INVERTER CIRCUIT, GATE DRIVE CIRCUIT, AND DISPLAY DEVICE

(71) Applicant: HKC CORPORATION LIMITED, Shenzhen (CN)

(72) Inventors: Xin YUAN, Shenzhen (CN); Xiufeng ZHOU, Shenzhen (CN); Chen CHEN, Shenzhen (CN); Lidan YE, Shenzhen (CN)

(21) Appl. No.: 19/233,466

(22) Filed: Jun. 10, 2025

(30) Foreign Application Priority Data
Jun. 11, 2024 (CN) 202410745373.5

(51) Int. Cl. G09G 3/20

(52) U.S. Cl. CPC G09G 3/2092; G09G 2310/0267; G09G 2310/0294; G09G 2310/08

(57) ABSTRACT

An inverter circuit, a gate drive circuit, and a display device are provided in the disclosure. The inverter circuit includes an inverted-signal output terminal, a first transistor, and a second transistor. A first connection terminal of the first transistor is electrically connected to the inverted-signal output terminal, a second connection terminal of the first transistor is configured to receive a first low-level voltage, and a control terminal of the first transistor is configured to receive an input signal. A first connection terminal and a first control terminal of the second transistor are both configured to receive a high-level voltage, and a second connection terminal of the second transistor is electrically connected to the inverted-signal output terminal. When the input signal is at a low level, the inverted-signal output terminal outputs a high-level signal. When the input signal is at a high level, the inverted-signal output terminal outputs a low-level signal.

### CROSS-REFERENCE TO RELATED APPLICATIONS

This application claims priority under 35 U.S.C. § 119(a) to Chinese Patent Application No. 202410745373.5, filed Jun. 11, 2024, the entire disclosure of which is incorporated herein by reference.

### TECHNICAL FIELD

This disclosure relates to the field of display technology, in particular to an inverter circuit, a gate drive circuit, and a display device.

### BACKGROUND

At present, compared with gate chip on film (gate COF) technology, gate driven on array (GOA) technology has great advantages in terms of cost and functionality, and thus has become a key development direction of panel manufacturers.

In the related art, with the arrangement of an inverter circuit in a GOA unit, the inverter circuit is used for pull-down holding of a PU node level. However, since an existing inverter circuit may generate a through-current between VGH and VGL during pull-down of the PU node level, especially when array units increase, for example, to more than 1000 stages, the accumulated through-current will affect voltage levels of VGH and VGL and lead to excessive heating of a screen body.

### SUMMARY

To achieve the above objective, an inverter circuit is provided in a first aspect of the disclosure. The inverter circuit includes an inverted-signal output terminal, a first transistor, and a second transistor. The first transistor includes a control terminal, a first connection terminal, and a second connection terminal. The first connection terminal of the first transistor is electrically connected to the inverted-signal output terminal, the second connection terminal of the first transistor is configured to receive a first low-level voltage, and the control terminal of the first transistor is configured to receive an input signal. The second transistor includes a first control terminal, a second control terminal, a first connection terminal, and a second connection terminal. The first connection terminal and the first control terminal of the second transistor are both configured to receive a high-level voltage, and the second connection terminal of the second transistor is electrically connected to the inverted-signal output terminal. When the input signal is at a low level, the first transistor is turned off in response to the input signal, and the second transistor is turned on since both the first connection terminal and the first control terminal of the second transistor receive the high-level voltage, to cause the inverted-signal output terminal to receive the high-level voltage through the second transistor and output a high-level signal. When the input signal is at a high level, the first transistor is turned on in response to the input signal, and the second transistor is configured to output a first on-current through the second connection terminal of the second transistor in response to a first control voltage received by the second control terminal, to cause the inverted-signal output terminal to output a low-level signal. An on-impedance of the second transistor when the second transistor outputs the first on-current is higher than an on-impedance of the first transistor when the first transistor is turned on, and the first on-current output from the second transistor varies with the first control voltage.

A gate drive circuit is further provided in a second aspect of the disclosure. The gate drive circuit includes multiple stages of gate drive units that are cascaded. Each stage of gate drive unit includes a scan-signal output terminal, a first node, a pull-up module, an output module, a pull-down holding module, and the inverter circuit described above in the first aspect. The pull-up module is electrically connected to the first node, and is configured to pull up the first node to a high level in response to a start signal of a present stage of gate drive unit. The output module includes a first connection terminal, a second connection terminal, and a control terminal. The control terminal of the output module is electrically connected to the first node. The first connection terminal of the output module is configured to receive a clock signal of the present stage of gate drive unit. The second connection terminal of the output module is electrically connected to the scan-signal output terminal. The output module is configured to output, when the first node is at the high level, a scan signal through the scan-signal output terminal based on a clock signal received by the first connection terminal. The pull-down holding module is electrically connected to both the first node and the scan-signal output terminal. The inverter circuit is electrically connected to both the first node and the pull-down holding module, and the inverter circuit is configured to control the pull-down holding module to hold the scan-signal output terminal and the first node at the low level after the first node is pulled down to the low level.

A display device is further provided in a third aspect of the disclosure. The display device includes a display panel and the gate drive circuit described above in the second aspect. The gate drive circuit is electrically connected to the display panel.

### BRIEF DESCRIPTION OF THE DRAWINGS

FIG. 1 is a schematic diagram of a circuit structure of an inverter circuit in the related art.

FIG. 2 is a first schematic diagram of a circuit structure of an inverter circuit provided in embodiments of the disclosure.

FIG. 3 is a transfer characteristic curve of a dual-gate thin film transistor provided in the disclosure.

FIG. 4 is a schematic cross-sectional structural diagram of a dual-gate thin film transistor provided in the disclosure.

FIG. 5 is a second schematic diagram of a circuit structure of an inverter circuit provided in embodiments of the disclosure.

FIG. 6 is a third schematic diagram of a circuit structure of an inverter circuit provided in embodiments of the disclosure.

FIG. 7 is a fourth schematic diagram of a circuit structure of an inverter circuit provided in embodiments of the disclosure.

FIG. 8 is a fifth schematic diagram of a circuit structure of an inverter circuit provided in embodiments of the disclosure.

FIG. 9 is a sixth schematic diagram of a circuit structure of an inverter circuit provided in embodiments of the disclosure.

FIG. 10 is a schematic structural diagram of a display device provided in embodiments of the disclosure.

FIG. 11 is a schematic diagram of a circuit structure of a stage of gate drive unit in the display device illustrated in FIG. 10.

FIG. 12 is a timing diagram of signals of the display device illustrated in FIG. 10.

The following detailed description of the disclosure will be further explained with reference to the above drawings.

### DETAILED DESCRIPTION

The following will describe technical solutions of embodiments of the disclosure clearly and completely with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

In addition, the terms “first”, “second”, and the like used in the specification of the disclosure are used to distinguish similar objects rather than describe a particular order or a precedence order. It may be understood that, the data used that way may be interchangeable where appropriate, so that the embodiments of the disclosure described herein can be implemented in sequences other than those illustrated or described herein. Furthermore, the terms “include”, “comprise”, and “have” as well as variations thereof are intended to cover non-exclusive inclusion. For example, a procedure, a method, a system, a product, or a device that includes a series of operations or units is not necessarily limited to those operations or units that are listed explicitly, but may include other operations or units that are not listed explicitly or include other operations or units that are inherent to such a procedure, a method, a product, or a device.

It may be noted that, features in the embodiments of the disclosure can be mutually combined in case of no conflict.

In view of the above, an inverter circuit, a gate drive circuit, and a display device are provided in the disclosure, which aims to solve the problem that an excessive through-current in an existing GOA unit affects voltage levels of VGH and VGL and leads to excessive heating of a screen body.

To achieve the above objective, an inverter circuit is provided in the disclosure. The inverter circuit includes an inverted-signal output terminal, a first transistor, and a second transistor. The first transistor includes a control terminal, a first connection terminal, and a second connection terminal. The first connection terminal of the first transistor is electrically connected to the inverted-signal output terminal, the second connection terminal of the first transistor is configured to receive a first low-level voltage, and the control terminal of the first transistor is configured to receive an input signal. The second transistor includes a first control terminal, a second control terminal, a first connection terminal, and a second connection terminal. The first connection terminal and the first control terminal of the second transistor are both configured to receive a high-level voltage, and the second connection terminal of the second transistor is electrically connected to the inverted-signal output terminal. When the input signal is at a low level, the first transistor is turned off in response to the input signal, and the second transistor is turned on since both the first connection terminal and the first control terminal of the second transistor receive the high-level voltage, to cause the inverted-signal output terminal to receive the high-level voltage through the second transistor and output a high-level signal. When the input signal is at a high level, the first transistor is turned on in response to the input signal, and the second transistor is configured to output a first on-current through the second connection terminal of the second transistor in response to a first control voltage received by the second control terminal, to cause the inverted-signal output terminal to output a low-level signal. An on-impedance of the second transistor when the second transistor outputs the first on-current is higher than an on-impedance of the first transistor when the first transistor is turned on, and the first on-current output from the second transistor varies with the first control voltage.

In the inverter circuit provided in the disclosure, the second transistor provided with the first control terminal and the second control terminal is used as a pull-up transistor. As such, when the input signal is at the high level, through adjustment of the first control voltage input to the second control terminal of the second transistor, an on-degree of the second transistor can be reduced, an on-current of the second transistor can be reduced, and a through-current of the inverter circuit can be reduced. Therefore, it can be ensured that voltage levels of VGH and VGL1 will not be affected, device heating can be reduced, and without designing the first transistor to have an excessively large device size, the inverted-signal output terminal can output a signal having an opposite level to the input signal, which facilitates the narrow-bezel design of the display device.

In some embodiments, the inverter circuit further includes an adjusting sub-circuit. The adjusting sub-circuit includes a control terminal and a control-voltage output terminal. The control terminal of the adjusting sub-circuit is configured to receive the input signal, and the control-voltage output terminal of the adjusting sub-circuit is electrically connected to the second control terminal of the second transistor. The adjusting sub-circuit is configured to output the first control voltage to the second control terminal of the second transistor in response to the input signal at the high level.

In some embodiments, the adjusting sub-circuit includes a third transistor. The third transistor includes a control terminal, a first connection terminal, and a second connection terminal. The control terminal of the third transistor is the control terminal of the adjusting sub-circuit, the second connection terminal of the third transistor is configured to receive a second low-level voltage, and the first connection terminal of the third transistor is the control-voltage output terminal of the adjusting sub-circuit. The third transistor is turned off in response to the input signal at the low level, and is turned on in response to the input signal at the high level and is configured to output the first control voltage to the second control terminal of the second transistor through the first connection terminal of the third transistor. The first control voltage is the second low-level voltage.

In some embodiments, the first low-level voltage is equal to the second low-level voltage. The inverter circuit further includes a first voltage terminal and a second voltage terminal. The first voltage terminal is electrically connected to both the first connection terminal and the first control terminal of the second transistor, and is configured to output the high-level voltage to the first connection terminal and the first control terminal of the second transistor. The second voltage terminal is electrically connected to both the second connection terminal of the first transistor and the second connection terminal of the third transistor, and is configured to output the first low-level voltage to the second connection terminal of the first transistor and the second connection terminal of the third transistor.

In some embodiments, the inverter circuit further includes a first voltage terminal, a second voltage terminal, and a third voltage terminal. The first voltage terminal is electrically connected to both the first connection terminal and the first control terminal of the second transistor, and is configured to output the high-level voltage to the first connection terminal and the first control terminal of the second transistor. The second voltage terminal is electrically connected to the second connection terminal of the first transistor, and is configured to output the first low-level voltage to the second connection terminal of the first transistor. The third voltage terminal is electrically connected to the second connection terminal of the third transistor, and is configured to output the second low-level voltage to the second connection terminal of the third transistor.

In some embodiments, the adjusting sub-circuit is further configured to output a second control voltage to the second control terminal of the second transistor when the inverted-signal output terminal outputs the high-level signal, to cause the second transistor to be turned on and output a second on-current through the second connection terminal of the second transistor. The second control voltage is greater than the first control voltage, and the second on-current is greater than the first on-current.

In some embodiments, the adjusting sub-circuit further includes a capacitor, a first terminal of the capacitor is electrically connected to the control-voltage output terminal of the adjusting sub-circuit, and a second terminal of the capacitor is electrically connected to the inverted-signal output terminal. The adjusting sub-circuit is configured to output the second control voltage through the control-voltage output terminal based on a bootstrap effect of the capacitor, when the inverted-signal output terminal changes from outputting the low-level signal to outputting the high-level signal.

In some embodiments, the adjusting sub-circuit further includes a fourth transistor. The fourth transistor includes a control terminal, a first connection terminal, and a second connection terminal. The control terminal of the fourth transistor is electrically connected to the inverted-signal output terminal, the first connection terminal of the fourth transistor is configured to receive the high-level voltage, and the second connection terminal of the fourth transistor is electrically connected to the second control terminal of the second transistor. The fourth transistor is turned on in response to the high-level signal output from the inverted-signal output terminal, to output the high-level voltage to the second control terminal of the second transistor. The second control voltage is the high-level voltage.

A gate drive circuit is further provided in the disclosure. The gate drive circuit includes multiple stages of gate drive units that are cascaded. Each stage of gate drive unit includes a scan-signal output terminal, a first node, a pull-up module, an output module, a pull-down holding module, and the inverter circuit described above. The pull-up module is electrically connected to the first node, and is configured to pull up the first node to a high level in response to a start signal of a present stage of gate drive unit. The output module includes a first connection terminal, a second connection terminal, and a control terminal. The control terminal of the output module is electrically connected to the first node. The first connection terminal of the output module is configured to receive a clock signal of the present stage of gate drive unit. The second connection terminal of the output module is electrically connected to the scan-signal output terminal. The output module is configured to output, when the first node is at the high level, a scan signal through the scan-signal output terminal based on a clock signal received by the first connection terminal. The pull-down holding module is electrically connected to both the first node and the scan-signal output terminal. The inverter circuit is electrically connected to both the first node and the pull-down holding module, and the inverter circuit is configured to control the pull-down holding module to hold the scan-signal output terminal and the first node at the low level after the first node is pulled down to the low level.

A display device is further provided in the disclosure. The display device includes a display panel and the gate drive circuit described above. The gate drive circuit is electrically connected to the display panel.

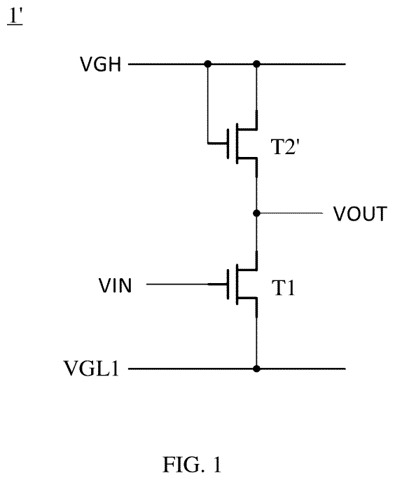

Reference can be made to FIG. 1, where FIG. 1 is a schematic diagram of a circuit structure of an inverter circuit in the related art. The inverter circuit 1′ is applied to a gate drive unit GOA in a display device. As illustrated in FIG. 1, the inverter circuit 1′ includes a signal input terminal VIN, an inverted-signal output terminal VOUT, a first transistor T1, and a second transistor T2′.

In embodiments of the disclosure, VIN represents both the signal input terminal and an input signal received by the signal input terminal, VOUT represents both the inverted-signal output terminal and a signal output from the inverted-signal output terminal, VGH represents both a first voltage terminal and a high-level voltage provided by the first voltage terminal, and VGL1 represents both a second voltage terminal and a first low-level voltage provided by the second voltage terminal.

A gate and a drain of the second transistor T2′ are both electrically connected to the first voltage terminal VGH, a source of the second transistor T2′ is electrically connected to the inverted-signal output terminal VOUT, a drain of the first transistor T1 is electrically connected to the inverted-signal output terminal VOUT, a gate of the first transistor T1 is electrically connected to the signal input terminal VIN, and a source of the first transistor T1 is electrically connected to the second voltage terminal VGL1. The first transistor T1 and the second transistor T2′ are both N-type transistors, that is, the first transistor T1 and the second transistor T2′ are turned on when the gates receive high-level signals.

The inverter circuit 1′is configured to invert the input signal VIN, that is, when VIN is at a high level, VOUT is at a low level, and when VIN is at the low level, VOUT is at the high level. Specifically, when an input VIN is at the low level, the first transistor T1 is turned off, the second transistor T2′ is turned on, and in this case, the inverted-signal output terminal VOUT outputs a high-level signal. When the input VIN is at the high level, the first transistor T1 is turned on, and the second transistor T2′ is also turned on. However, since a device size of the first transistor T1 is much greater than a device size of the second transistor T2′, an on-impedance of the first transistor T1 is much smaller than an on-impedance of the second transistor T2′, and the signal output from the inverted-signal output terminal VOUT is closer to the first low-level voltage VGL1 but slightly higher than the first low-level voltage VGL1. Since both the first transistor T1 and the second transistor T2′ are turned on, a through-current exists between the first voltage terminal VGH and the second voltage terminal VGL1. Therefore, when the display device includes a large number of gate drive units GOA, for example, reaching more than 1000 stages, the accumulated through-current will affect voltage levels of the high-level voltage VGH and the first low-level voltage VGL1, and also lead to excessive heating of the display device. In addition, since the device size of the first transistor T1 needs to be designed to be greater than ten times the device size of the second transistor T2′, the narrow-bezel design of the display device is unfavorable.

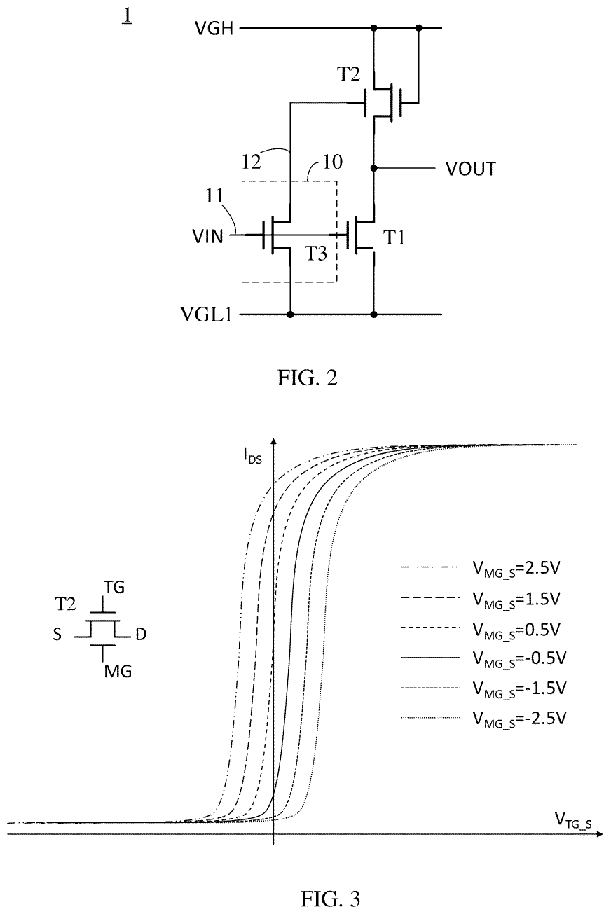

As illustrated in FIG. 2, in order to solve the problem that an excessive through-current in an existing gate drive unit GOA affects voltage levels of VGH and VGL1, leads to excessive heating of a screen body, and does not facilitate the narrow-bezel design of the display device, an inverter circuit 1 is provided in the disclosure. The inverter circuit 1 includes an inverted-signal output terminal VOUT, a first transistor T1, and a second transistor T2.

The first transistor T1 includes a control terminal, a first connection terminal, and a second connection terminal. The first connection terminal of the first transistor T1 is electrically connected to the inverted-signal output terminal VOUT, the second connection terminal of the first transistor T1 is configured to receive a first low-level voltage VGL1, and the control terminal of the first transistor T1 is configured to receive an input signal VIN.

The second transistor T2 includes a first control terminal, a second control terminal, a first connection terminal, and a second connection terminal. The first connection terminal and the first control terminal of the second transistor T2 are both configured to receive a high-level voltage, and the second connection terminal of the second transistor T2 is electrically connected to the inverted-signal output terminal VOUT.

When the input signal VIN is at a low level, the first transistor T1 is turned off in response to the input signal VIN, and the second transistor T2 is turned on since both the first connection terminal and the first control terminal of the second transistor T2 receive the high-level voltage, to cause the inverted-signal output terminal VOUT to receive the high-level voltage through the second transistor T2 and output a high-level signal. When the input signal VIN is at a high level, the first transistor T1 is turned on in response to the input signal VIN, and the second transistor T2 is configured to output a first on-current through the second connection terminal of the second transistor in response to a first control voltage received by the second control terminal, to cause the inverted-signal output terminal VOUT to output a low-level signal. An on-impedance of the second transistor T2 when the second transistor T2 outputs the first on-current is higher than an on-impedance of the first transistor T1 when the first transistor T1 is turned on, and the first on-current output from the second transistor T2 varies with the first control voltage.

In the inverter circuit 1 provided in the disclosure, the second transistor T2 provided with the first control terminal and the second control terminal is used as a pull-up transistor. As such, when the input signal is at the high level, through adjustment of the first control voltage input to the second control terminal of the second transistor T2, an on-degree of the second transistor T2 can be reduced, an on-current of the second transistor T2 can be reduced, and a through-current of the inverter circuit 1 can be reduced. Therefore, it can be ensured that voltage levels of VGH and VGL1 will not be affected, device heating can be reduced, and without designing the first transistor T1 to have an excessively large device size, the inverted-signal output terminal VOUT can output a signal having an opposite level to the input signal, which facilitates the narrow-bezel design of the display device.

In embodiments of the disclosure, the first transistor T1 may be an N-type thin film transistor (TFT). The control terminal, the first connection terminal, and the second connection terminal of the first transistor T1 are in one-to-one correspondence with a gate, a drain, and a source of the N-type thin film transistor.

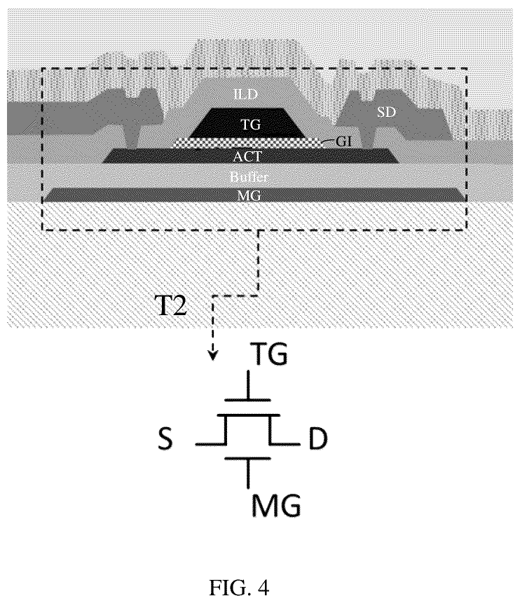

Reference can be made to FIG. 3 and FIG. 4, where FIG. 3 is a transfer characteristic curve of a dual-gate thin film transistor provided in the disclosure, and FIG. 4 is a schematic cross-sectional structural diagram of a dual-gate thin film transistor provided in the disclosure. The second transistor T2 may be an N-type dual-gate thin film transistor. The first control terminal, the second control terminal, the first connection terminal, and the second connection terminal of the second transistor T2 are in one-to-one correspondence with a top gate, a bottom gate, a drain, and a source of the N-type dual-gate thin film transistor.

As illustrated in FIG. 3, I_{DS} represents an on-current of the second transistor T2, V_{TG_S} represents a voltage difference between a top gate TG and a source S of the second transistor T2, i.e., V_{TG_S}=V_{TG}−Vₛ, and V_{MG_S} represents a voltage difference between a bottom gate (e.g., modulate gate) MG and the source S of the second transistor T2, i.e., V_{MG_S}=V_{MG}−Vₛ. As can be seen from FIG. 3, when V_{MG_S}<0, a transfer characteristic curve of the second transistor T2 shifts in a positive direction, that is, a threshold voltage Vth of the second transistor T2 increases. Therefore, when V_{TG_S} remains unchanged, by reducing a control voltage received by the second control terminal of the second transistor T2, the on-degree of the second transistor T2 can be reduced, and the on-current of the second transistor T2 can be reduced, and thus the through-current of the inverter circuit 1 can be reduced.

As illustrated in FIG. 4, the second transistor T2 may include a bottom gate MG, a buffer layer Buffer, an active layer ACT, a gate insulating layer GI, a top gate TG, an interlayer dielectric layer ILD, and a source-drain layer SD which are stacked in sequence. The interlayer dielectric layer ILD defines a via hole for connecting the active layer ACT to a source S and a drain D in the source-drain layer SD.

In some embodiments, the inverter circuit 1 further includes an adjusting sub-circuit 10. The adjusting sub-circuit 10 includes a control terminal 11 and a control-voltage output terminal 12. The control terminal 11 of the adjusting sub-circuit 10 is configured to receive the input signal VIN, and the control-voltage output terminal 12 of the adjusting sub-circuit 10 is electrically connected to the second control terminal of the second transistor T2. The adjusting sub-circuit 10 is configured to output the first control voltage to the second control terminal of the second transistor T2 in response to the input signal VIN at the high level.

Further, the adjusting sub-circuit 10 includes a third transistor T3. The third transistor T3 includes a control terminal, a first connection terminal, and a second connection terminal. The control terminal of the third transistor T3 is the control terminal 11 of the adjusting sub-circuit 10, the second connection terminal of the third transistor T3 is configured to receive a second low-level voltage, and the first connection terminal of the third transistor T3 is the control-voltage output terminal 12 of the adjusting sub-circuit 10. The third transistor T3 is turned off in response to the input signal VIN at the low level. The third transistor T3 is further turned on in response to the input signal VIN at the high level, and is configured to output the first control voltage to the second control terminal of the second transistor T2 through the first connection terminal of the third transistor T3. The first control voltage is the second low-level voltage.

In embodiments of the disclosure, the third transistor T3 may be an N-type thin film transistor. The control terminal, the first connection terminal, and the second connection terminal of the third transistor T3 are in one-to-one correspondence with a gate, a drain, and a source of the N-type thin film transistor.

In some embodiments, the first low-level voltage is equal to the second low-level voltage. The inverter circuit 1 further includes a first voltage terminal VGH and a second voltage terminal VGL1. As illustrated in FIG. 2, the first voltage terminal VGH is electrically connected to both the first connection terminal and the first control terminal of the second transistor T2, and is configured to output the high-level voltage to the first connection terminal and the first control terminal of the second transistor T2. The second voltage terminal VGL1 is electrically connected to both the second connection terminal of the first transistor T1 and the second connection terminal of the third transistor T3, and is configured to output the first low-level voltage to the second connection terminal of the first transistor T1 and the second connection terminal of the third transistor T3.

As such, the inverter circuit 1 needs to be provided with only one low-level voltage terminal, which has a simpler circuit structure.

In some embodiments, the adjusting sub-circuit 10 is further configured to output a second control voltage to the second control terminal of the second transistor T2 when the inverted-signal output terminal VOUT outputs the high-level signal, to cause the second transistor T2 to be turned on and output a second on-current through the second connection terminal of the second transistor T2. The second control voltage is greater than the first control voltage, and the second on-current is greater than the first on-current.

As such, when the input signal changes from the high level to the low level, a control voltage output from the adjusting sub-circuit 10 to the second control terminal of the second transistor T2 increases from the first control voltage to the second control voltage, which can improve the on-degree of the second transistor T2, so that the on-current output from the second transistor T2 increases from the first on-current to the second on-current. Therefore, the inverted-signal output terminal VOUT has a faster charging rate and a faster level-switching rate.

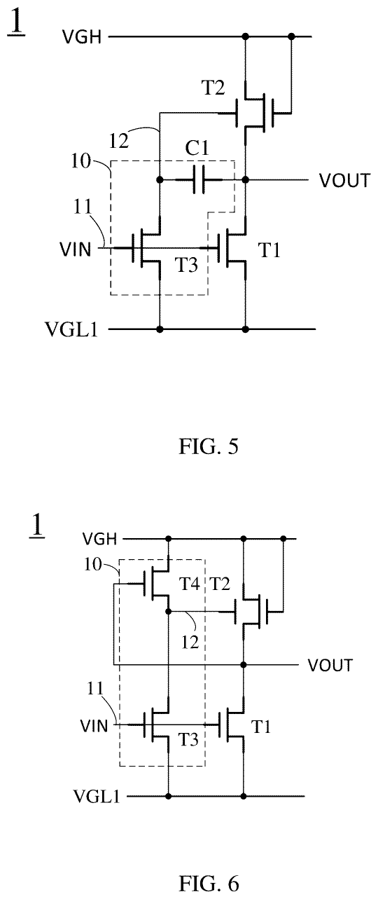

Further, reference can be made to FIG. 5, where FIG. 5 is a second schematic diagram of a circuit structure of an inverter circuit provided in embodiments of the disclosure. The inverter circuit 1 illustrated in FIG. 5 has a circuit structure similar to the inverter circuit 1 illustrated in FIG. 4. The only difference lies in that in the inverter circuit 1 illustrated in FIG. 5, the adjusting sub-circuit 10 further includes a capacitor C1. A first terminal of the capacitor C1 is electrically connected to the control-voltage output terminal 12 of the adjusting sub-circuit 10, and a second terminal of the capacitor Cl is electrically connected to the inverted-signal output terminal VOUT.

The adjusting sub-circuit 10 is configured to output the second control voltage through the control-voltage output terminal 12 based on a bootstrap effect of the capacitor C1, when the inverted-signal output terminal VOUT changes from outputting the low-level signal to outputting the high-level signal.

Specifically, during operation, when the input signal is at the high level, both the first transistor T1 and the third transistor T3 are turned on. Therefore, a voltage of a signal output from the inverted-signal output terminal VOUT is VGL1, and voltages at the first terminal and the second terminal of the capacitor C1 are equal and both VGL1, that is, a voltage difference between the two terminals of the capacitor Cl is zero. When the input signal changes from the high level to the low level, both the first transistor T1 and the third transistor T3 are turned off, and thus the voltage of the signal output from the inverted-signal output terminal VOUT increases from VGL1 to VGH. In this case, due to the bootstrap effect of the capacitor C1, the voltage difference between the two terminals of the capacitor C1 remains zero, so that the voltage at the first terminal of the capacitor C1 also increases from VGL1 to VGH, that is, a control voltage output from the control-voltage output terminal 12 increases from the first control voltage (i.e., VGL1) to the second control voltage (i.e., VGH).

Reference can be made to FIG. 6, where FIG. 6 is a third schematic diagram of a circuit structure of an inverter circuit provided in embodiments of the disclosure. The inverter circuit 1 illustrated in FIG. 6 has a circuit structure similar to the inverter circuit 1 illustrated in FIG. 4. The only difference lies in that in the inverter circuit 1 illustrated in FIG. 6, the adjusting sub-circuit 10 further includes a fourth transistor T4. The fourth transistor T4 includes a control terminal, a first connection terminal, and a second connection terminal. The control terminal of the fourth transistor T4 is electrically connected to the inverted-signal output terminal VOUT, the first connection terminal of the fourth transistor T4 is configured to receive the high-level voltage, and the second connection terminal of the fourth transistor T4 is electrically connected to the second control terminal of the second transistor T2. The fourth transistor T4 is turned on in response to the high-level signal output from the inverted-signal output terminal VOUT, to output the high-level voltage to the second control terminal of the second transistor T2. The second control voltage is the high-level voltage.

In embodiments of the disclosure, the fourth transistor T4 may be an N-type thin film transistor. The control terminal, the first connection terminal, and the second connection terminal of the fourth transistor T4 are in one-to-one correspondence with a gate, a drain, and a source of the N-type thin film transistor.

Specifically, during operation, when the input signal is at the high level, both the first transistor T1 and the third transistor T3 are turned on, and the fourth transistor T4 is turned off. Therefore, a voltage of a signal output from the inverted-signal output terminal VOUT is VGL1, and the first control voltage (i.e., VGL1) is received by the second control terminal of the second transistor T2. When the input signal changes from the high level to the low level, both the first transistor T1 and the third transistor T3 are turned off, and the fourth transistor T4 is turned on, and thus the voltage of the signal output from the inverted-signal output terminal VOUT increases from VGL1 to VGH. In addition, a control voltage output from the control-voltage output terminal 12 increases from the first control voltage (i.e., VGL1) to the second control voltage (i.e., VGH).

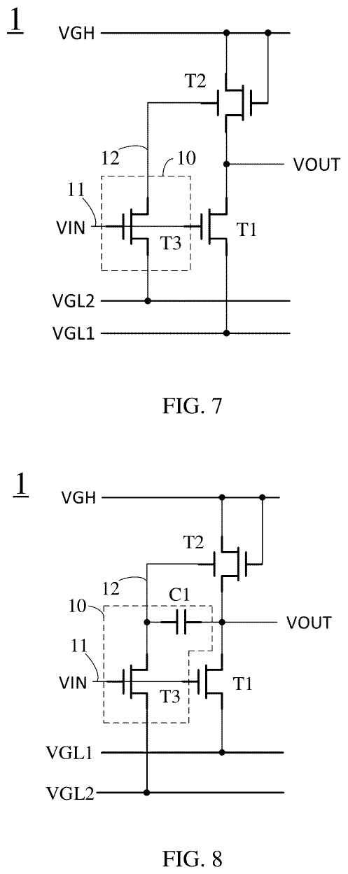

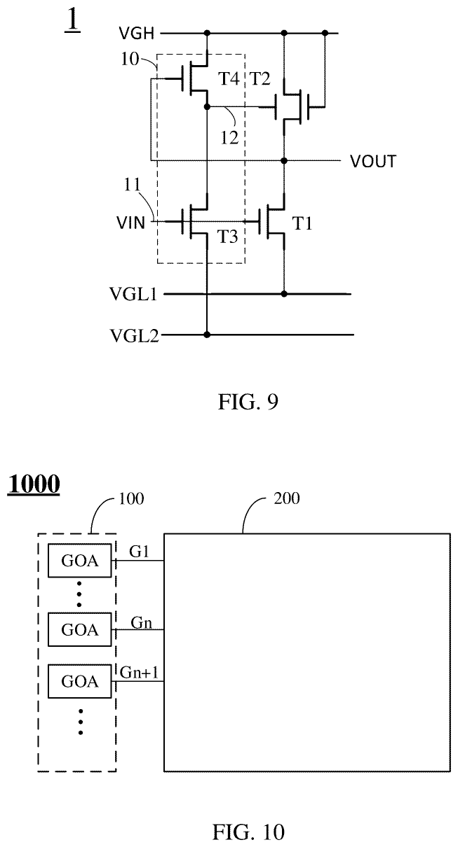

Reference can be made to FIG. 7 to FIG. 9, where FIG. 7 is a fourth schematic diagram of a circuit structure of an inverter circuit provided in embodiments of the disclosure, FIG. 8 is a fifth schematic diagram of a circuit structure of an inverter circuit provided in embodiments of the disclosure, and FIG. 9 is a sixth schematic diagram of a circuit structure of an inverter circuit provided in embodiments of the disclosure. The inverter circuit 1 illustrated in FIG. 7 has a circuit structure similar to the inverter circuit 1 illustrated in FIG. 4, the inverter circuit 1 illustrated in FIG. 8 has a circuit structure similar to the inverter circuit 1 illustrated in FIG. 5, and the inverter circuit 1 illustrated in FIG. 9 has a circuit structure similar to the inverter circuit 1 illustrated in FIG. 6. The only difference between the inverter circuit 1 illustrated in FIG. 7 and the inverter circuit 1 illustrated in FIG. 4, between the inverter circuit 1 illustrated in FIG. 8 and the inverter circuit 1 illustrated in FIG. 5, and between the inverter circuit 1 illustrated in FIG. 9 and the inverter circuit 1 illustrated in FIG. 6 lies in that the inverter circuit 1 illustrated in each of FIG. 7 to FIG. 9 further includes a third voltage terminal VGL2.

Specifically, in the inverter circuit 1 illustrated in each of FIG. 7 to FIG. 9, the first voltage terminal VGH is electrically connected to both the first connection terminal and the first control terminal of the second transistor T2, and is configured to output the high-level voltage to the first connection terminal and the first control terminal of the second transistor T2.

The second voltage terminal VGL1 is electrically connected to the second connection terminal of the first transistor T1, and is configured to output the first low-level voltage to the second connection terminal of the first transistor T1.

The third voltage terminal VGL2 is electrically connected to the second connection terminal of the third transistor T3, and is configured to output the second low-level voltage to the second connection terminal of the third transistor T3.

During operation, when the input signal is at the high level, both the first transistor T1 and the third transistor T3 are turned on, so that the inverted-signal output terminal VOUT is pulled down by the first low-level voltage VGL1. In this case, for the second transistor T2, the first control voltage received by the second control terminal is VGL2, and V_{MG_S}=V_{MG}−Vₛ≈VGL2−VGL1. As such, by reducing a voltage value of the second low-level voltage VGL2, a threshold voltage Vth of the second transistor T2 can be increased, thereby reducing the first on-current of the second transistor T2, and providing a wider adjustable range.

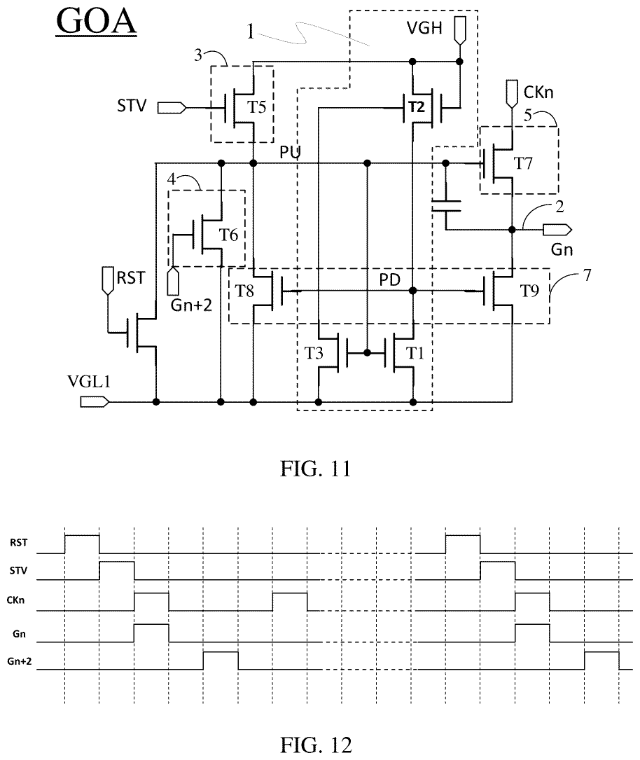

Reference can be made to FIG. 10 to FIG. 12, where FIG. 10 is a schematic structural diagram of a display device provided in embodiments of the disclosure, FIG. 11 is a schematic diagram of a circuit structure of a stage of gate drive unit in the display device illustrated in FIG. 10, and FIG. 12 is a timing diagram of signals of the display device illustrated in FIG. 10. Based on the same inventive concept, a gate drive circuit 100 is further provided in the disclosure. The gate drive circuit 100 includes multiple stages of gate drive units GOA that are cascaded. Each stage of gate drive unit GOA includes a scan-signal output terminal 2, a first node PU, a pull-up module 3, an output module 5, a pull-down holding module 7, and the inverter circuit 1 described in any one of the foregoing embodiments.

The pull-up module 3 is electrically connected to the first node PU. The pull-up module 3 is configured to pull up the first node PU to a high level in response to a start signal of a present stage of gate drive unit GOA.

The output module 5 includes a first connection terminal, a second connection terminal, and a control terminal. The control terminal of the output module 5 is electrically connected to the first node PU. The first connection terminal of the output module 5 is configured to receive a clock signal of the present stage of gate drive unit GOA. The second connection terminal of the output module 5 is electrically connected to the scan-signal output terminal 2. The output module 5 is configured to output, when the first node PU is at the high level, a scan signal through the scan-signal output terminal 2 based on a clock signal received by the first connection terminal.

The pull-down holding module 7 is electrically connected to both the first node PU and the scan-signal output terminal 2.

The inverter circuit 1 is electrically connected to both the first node PU and the pull-down holding module 7. The inverter circuit 1 is configured to control the pull-down holding module 7 to hold the scan-signal output terminal 2 and the first node PU at the low level after the first node PU is pulled down to the low level.

A start signal of a first stage of gate drive unit GOA is a frame start signal STV, and a start signal of a gate drive unit GOA other than the first stage of gate drive unit GOA is a scan signal output from a previous stage of gate drive unit GOA. A scan signal output from the first stage of gate drive unit GOA is G1, a scan signal output from the n-th stage of gate drive unit GOA is Gn, a scan signal output from the (n+1)-th stage of gate drive unit GOA is Gn+1, and a clock signal of the n-th stage of gate drive unit GOA is CKn.

Specifically, as illustrated in FIG. 11, the gate drive unit GOA further includes a second node PD. The pull-up module 3 includes a fifth transistor T5. A gate of the fifth transistor T5 is configured to receive the start signal of the present stage of gate drive unit GOA, a drain of the fifth transistor T5 is configured to receive the high-level voltage, and a source of the fifth transistor T5 is electrically connected to the first node PU. The fifth transistor T5 is turned on in response to the start signal of the present stage of gate drive unit GOA, to pull up the first node PU to the high level.

The output module 5 includes a seventh transistor T7. A gate, a drain, and a source of the seventh transistor T7 are in one-to-one correspondence with the control terminal, the first connection terminal, and the second connection terminal of the output module 5. When the first node PU is at the high level, the seventh transistor T7 is turned on, to output the scan signal through the scan-signal output terminal 2 based on a received clock signal.

The pull-down holding module 7 includes an eighth transistor T8 and a ninth transistor T9. A drain of the eighth transistor T8 is electrically connected to the first node PU, and a source of the eighth transistor T8 is electrically connected to the second voltage terminal VGL1. A drain of the ninth transistor T9 is electrically connected to the scan-signal output terminal 2, and a source of the ninth transistor T9 is electrically connected to the second voltage terminal VGL1. A gate of the eighth transistor T8 and a gate of the ninth transistor T9 are both electrically connected to the inverted-signal output terminal VOUT of the inverter circuit 1, and an input signal received by the inverter circuit 1 is a voltage signal output from the first node PU. When the first node PU is pulled down to the low level, the inverter circuit 1 outputs a high-level signal to the eighth transistor T8 and the ninth transistor T9, so that both the eighth transistor T8 and the ninth transistor T9 are turned on, and thus the scan-signal output terminal 2 and the first node PU are held at the low level.

Further, the gate drive unit GOA further includes a pull-down module 4. The pull-down module 4 is configured to pull down the first node PU to the low level in response to a scan signal output from a subsequent second stage of gate drive unit GOA.

Specifically, the pull-down module 4 includes a sixth transistor T6. A gate of the sixth transistor T6 is configured to receive the scan signal output from the subsequent second stage of gate drive unit GOA, a drain of the sixth transistor T6 is electrically connected to the first node PU, and a source of the sixth transistor T6 is electrically connected to the second voltage terminal VGL1. The sixth transistor T6 is turned on in response to the scan signal output from the subsequent second stage of gate drive unit GOA, to pull down the first node PU to the low level.

In some embodiments, each stage of gate drive unit GOA further includes a reset module. The reset module is configured to reset the first node PU to the first low-level voltage VGL1 in response to a reset signal RST.

As illustrated in FIG. 10 again, based on the same inventive concept, a display device 1000 is further provided in the disclosure. The display device 1000 includes a display panel 200 and the gate drive circuit 100 described in the foregoing embodiments. The gate drive circuit 100 is electrically connected to the display panel 200.

For the gate drive circuit 100 and the display device 1000 provided in the disclosure, in the inverter circuit 1 in the gate drive unit GOA, the second transistor T2 provided with the first control terminal and the second control terminal is used as a pull-up transistor. As such, when the input signal is at the high level, through adjustment of the first control voltage input to the second control terminal of the second transistor T2, an on-degree of the second transistor T2 can be reduced, an on-current of the second transistor T2 can be reduced, and a through-current of the inverter circuit 1 can be reduced. Therefore, it can be ensured that voltage levels of VGH and VGL1 will not be affected, device heating can be reduced, and without designing the first transistor T1 to have an excessively large device size, the inverted-signal output terminal VOUT can output a signal having an opposite level to the input signal, which facilitates the narrow-bezel design of the display device.

It may be noted that, an on-impedance of a transistor has a negative correlation with a channel width-to-length ratio of the transistor. In other words, the greater the channel width-to-length ratio of the transistor, the smaller the on-impedance of the transistor, and the lower the on-voltage drop.

Although embodiments of the disclosure have been illustrated and described, it will be understood by those of ordinary skill in the art that various changes, modifications, substitutions, and modifications may be made to these embodiments without departing from the principles and purposes of the disclosure, and the scope of the disclosure is defined by the claims and their equivalents.

What is claimed is:

1. An inverter circuit, comprising:
an inverted-signal output terminal;
a first transistor comprising a control terminal, a first connection terminal, and a second connection terminal, wherein the first connection terminal of the first transistor is electrically connected to the inverted-signal output terminal, the second connection terminal of the first transistor is configured to receive a first low-level voltage, and the control terminal of the first transistor is configured to receive an input signal; and
a second transistor comprising a first control terminal, a second control terminal, a first connection terminal, and a second connection terminal, wherein the first connection terminal and the first control terminal of the second transistor are both configured to receive a high-level voltage, and the second connection terminal of the second transistor is electrically connected to the inverted-signal output terminal; wherein when the input signal is at a low level, the first transistor is turned off in response to the input signal, and the second transistor is turned on since both the first connection terminal and the first control terminal of the second transistor receive the high-level voltage, to cause the inverted-signal output terminal to receive the high-level voltage through the second transistor and output a high-level signal; wherein when the input signal is at a high level, the first transistor is turned on in response to the input signal, and the second transistor is configured to output a first on-current through the second connection terminal of the second transistor in response to a first control voltage received by the second control terminal, to cause the inverted-signal output terminal to output a low-level signal; and
wherein an on-impedance of the second transistor when the second transistor outputs the first on-current is higher than an on-impedance of the first transistor when the first transistor is turned on, and the first on-current output from the second transistor varies with the first control voltage.

2. The inverter circuit of claim 1, further comprising an adjusting sub-circuit, wherein the adjusting sub-circuit comprises a control terminal and a control-voltage output terminal, the control terminal of the adjusting sub-circuit is configured to receive the input signal, and the control-voltage output terminal of the adjusting sub-circuit is electrically connected to the second control terminal of the second transistor; and the adjusting sub-circuit is configured to output the first control voltage to the second control terminal of the second transistor in response to the input signal at the high level.

3. The inverter circuit of claim 2, wherein the adjusting sub-circuit comprises a third transistor, the third transistor comprises a control terminal, a first connection terminal, and a second connection terminal, the control terminal of the third transistor is the control terminal of the adjusting sub-circuit, the second connection terminal of the third transistor is configured to receive a second low-level voltage, and the first connection terminal of the third transistor is the control-voltage output terminal of the adjusting sub-circuit; the third transistor is turned off in response to the input signal at the low level, and is turned on in response to the input signal at the high level and is configured to output the first control voltage to the second control terminal of the second transistor through the first connection terminal of the third transistor; and the first control voltage is the second low-level voltage.

4. The inverter circuit of claim 3, wherein the first low-level voltage is equal to the second low-level voltage; the inverter circuit further comprises a first voltage terminal and a second voltage terminal; the first voltage terminal is electrically connected to both the first connection terminal and the first control terminal of the second transistor, and is configured to output the high-level voltage to the first connection terminal and the first control terminal of the second transistor; the second voltage terminal is electrically connected to both the second connection terminal of the first transistor and the second connection terminal of the third transistor, and is configured to output the first low-level voltage to the second connection terminal of the first transistor and the second connection terminal of the third transistor.

5. The inverter circuit of claim 3, further comprising:
a first voltage terminal electrically connected to both the first connection terminal and the first control terminal of the second transistor, and configured to output the high-level voltage to the first connection terminal and the first control terminal of the second transistor;
a second voltage terminal electrically connected to the second connection terminal of the first transistor, and configured to output the first low-level voltage to the second connection terminal of the first transistor; and
a third voltage terminal electrically connected to the second connection terminal of the third transistor, and configured to output the second low-level voltage to the second connection terminal of the third transistor.

6. The inverter circuit of claim 3, wherein the adjusting sub-circuit is further configured to output a second control voltage to the second control terminal of the second transistor when the inverted-signal output terminal outputs the high-level signal, to cause the second transistor to be turned on and output a second on-current through the second connection terminal of the second transistor; and the second control voltage is greater than the first control voltage, and the second on-current is greater than the first on-current.

7. The inverter circuit of claim 6, wherein the adjusting sub-circuit further comprises a capacitor, a first terminal of the capacitor is electrically connected to the control-voltage output terminal of the adjusting sub-circuit, and a second terminal of the capacitor is electrically connected to the inverted-signal output terminal; and
the adjusting sub-circuit is configured to output the second control voltage through the control-voltage output terminal based on a bootstrap effect of the capacitor, when the inverted-signal output terminal changes from outputting the low-level signal to outputting the high-level signal.

8. The inverter circuit of claim 6, wherein the adjusting sub-circuit further comprises a fourth transistor, the fourth transistor comprises a control terminal, a first connection terminal, and a second connection terminal, the control terminal of the fourth transistor is electrically connected to the inverted-signal output terminal, the first connection terminal of the fourth transistor is configured to receive the high-level voltage, and the second connection terminal of the fourth transistor is electrically connected to the second control terminal of the second transistor; the fourth transistor is turned on in response to the high-level signal output from the inverted-signal output terminal, to output the high-level voltage to the second control terminal of the second transistor; and the second control voltage is the high-level voltage.

9. A gate drive circuit, comprising multiple stages of gate drive units that are cascaded, wherein each stage of gate drive unit comprises:
a scan-signal output terminal;
a first node;
a pull-up module electrically connected to the first node, and configured to pull up the first node to a high level in response to a start signal of a present stage of gate drive unit;
an output module comprising a first connection terminal, a second connection terminal, and a control terminal, wherein the control terminal of the output module is electrically connected to the first node, the first connection terminal of the output module is configured to receive a clock signal of the present stage of gate drive unit, the second connection terminal of the output module is electrically connected to the scan-signal output terminal, and the output module is configured to output, when the first node is at the high level, a scan signal through the scan-signal output terminal based on a clock signal received by the first connection terminal;
a pull-down holding module electrically connected to both the first node and the scan-signal output terminal; and
an inverter circuit electrically connected to both the first node and the pull-down holding module, configured to control the pull-down holding module to hold the scan-signal output terminal and the first node at the low level after the first node is pulled down to the low level, and comprising:
an inverted-signal output terminal;
a first transistor comprising a control terminal, a first connection terminal, and a second connection terminal, wherein the first connection terminal of the first transistor is electrically connected to the inverted-signal output terminal, the second connection terminal of the first transistor is configured to receive a first low-level voltage, and the control terminal of the first transistor is configured to receive an input signal; and
a second transistor comprising a first control terminal, a second control terminal, a first connection terminal, and a second connection terminal, wherein the first connection terminal and the first control terminal of the second transistor are both configured to receive a high-level voltage, and the second connection terminal of the second transistor is electrically connected to the inverted-signal output terminal; wherein when the input signal is at a low level, the first transistor is turned off in response to the input signal, and the second transistor is turned on since both the first connection terminal and the first control terminal of the second transistor receive the high-level voltage, to cause the inverted-signal output terminal to receive the high-level voltage through the second transistor and output a high-level signal; wherein when the input signal is at a high level, the first transistor is turned on in response to the input signal, and the second transistor is configured to output a first on-current through the second connection terminal of the second transistor in response to a first control voltage received by the second control terminal, to cause the inverted-signal output terminal to output a low-level signal; and
wherein an on-impedance of the second transistor when the second transistor outputs the first on-current is higher than an on-impedance of the first transistor when the first transistor is turned on, and the first on-current output from the second transistor varies with the first control voltage.

10. The gate drive circuit of claim 9, wherein the inverter circuit further comprises an adjusting sub-circuit, wherein the adjusting sub-circuit comprises a control terminal and a control-voltage output terminal, the control terminal of the adjusting sub-circuit is configured to receive the input signal, and the control-voltage output terminal of the adjusting sub-circuit is electrically connected to the second control terminal of the second transistor; and the adjusting sub-circuit is configured to output the first control voltage to the second control terminal of the second transistor in response to the input signal at the high level.

11. The gate drive circuit of claim 10, wherein the adjusting sub-circuit comprises a third transistor, the third transistor comprises a control terminal, a first connection terminal, and a second connection terminal, the control terminal of the third transistor is the control terminal of the adjusting sub-circuit, the second connection terminal of the third transistor is configured to receive a second low-level voltage, and the first connection terminal of the third transistor is the control-voltage output terminal of the adjusting sub-circuit; the third transistor is turned off in response to the input signal at the low level, and is turned on in response to the input signal at the high level and is configured to output the first control voltage to the second control terminal of the second transistor through the first connection terminal of the third transistor; and the first control voltage is the second low-level voltage.

12. The gate drive circuit of claim 11, wherein the first low-level voltage is equal to the second low-level voltage; the inverter circuit further comprises a first voltage terminal and a second voltage terminal; the first voltage terminal is electrically connected to both the first connection terminal and the first control terminal of the second transistor, and is configured to output the high-level voltage to the first connection terminal and the first control terminal of the second transistor; the second voltage terminal is electrically connected to both the second connection terminal of the first transistor and the second connection terminal of the third transistor, and is configured to output the first low-level voltage to the second connection terminal of the first transistor and the second connection terminal of the third transistor.

13. The gate drive circuit of claim 11, wherein the inverter circuit further comprises:
a first voltage terminal electrically connected to both the first connection terminal and the first control terminal of the second transistor, and configured to output the high-level voltage to the first connection terminal and the first control terminal of the second transistor;
a second voltage terminal electrically connected to the second connection terminal of the first transistor, and configured to output the first low-level voltage to the second connection terminal of the first transistor; and
a third voltage terminal electrically connected to the second connection terminal of the third transistor, and configured to output the second low-level voltage to the second connection terminal of the third transistor.

14. The gate drive circuit of claim 11, wherein the adjusting sub-circuit is further configured to output a second control voltage to the second control terminal of the second transistor when the inverted-signal output terminal outputs the high-level signal, to cause the second transistor to be turned on and output a second on-current through the second connection terminal of the second transistor; and the second control voltage is greater than the first control voltage, and the second on-current is greater than the first on-current.

15. The gate drive circuit of claim 14, wherein the adjusting sub-circuit further comprises a capacitor, a first terminal of the capacitor is electrically connected to the control-voltage output terminal of the adjusting sub-circuit, and a second terminal of the capacitor is electrically connected to the inverted-signal output terminal; and
the adjusting sub-circuit is configured to output the second control voltage through the control-voltage output terminal based on a bootstrap effect of the capacitor, when the inverted-signal output terminal changes from outputting the low-level signal to outputting the high-level signal.

16. The gate drive circuit of claim 14, wherein the adjusting sub-circuit further comprises a fourth transistor, the fourth transistor comprises a control terminal, a first connection terminal, and a second connection terminal, the control terminal of the fourth transistor is electrically connected to the inverted-signal output terminal, the first connection terminal of the fourth transistor is configured to receive the high-level voltage, and the second connection terminal of the fourth transistor is electrically connected to the second control terminal of the second transistor; the fourth transistor is turned on in response to the high-level signal output from the inverted-signal output terminal, to output the high-level voltage to the second control terminal of the second transistor; and the second control voltage is the high-level voltage.

17. A display device, comprising:
a display panel; and
a gate drive circuit electrically connected to the display panel and comprising multiple stages of gate drive units that are cascaded, wherein each stage of gate drive unit comprises:
a scan-signal output terminal;
a first node;
a pull-up module electrically connected to the first node, and configured to pull up the first node to a high level in response to a start signal of a present stage of gate drive unit;
an output module comprising a first connection terminal, a second connection terminal, and a control terminal, wherein the control terminal of the output module is electrically connected to the first node, the first connection terminal of the output module is configured to receive a clock signal of the present stage of gate drive unit, the second connection terminal of the output module is electrically connected to the scan-signal output terminal, and the output module is configured to output, when the first node is at the high level, a scan signal through the scan-signal output terminal based on a clock signal received by the first connection terminal;
a pull-down holding module electrically connected to both the first node and the scan-signal output terminal; and
an inverter circuit electrically connected to both the first node and the pull-down holding module, configured to control the pull-down holding module to hold the scan-signal output terminal and the first node at the low level after the first node is pulled down to the low level, and comprising:
an inverted-signal output terminal;
a first transistor comprising a control terminal, a first connection terminal, and a second connection terminal, wherein the first connection terminal of the first transistor is electrically connected to the inverted-signal output terminal, the second connection terminal of the first transistor is configured to receive a first low-level voltage, and the control terminal of the first transistor is configured to receive an input signal; and
a second transistor comprising a first control terminal, a second control terminal, a first connection terminal, and a second connection terminal, wherein the first connection terminal and the first control terminal of the second transistor are both configured to receive a high-level voltage, and the second connection terminal of the second transistor is electrically connected to the inverted-signal output terminal; wherein when the input signal is at a low level, the first transistor is turned off in response to the input signal, and the second transistor is turned on since both the first connection terminal and the first control terminal of the second transistor receive the high-level voltage, to cause the inverted-signal output terminal to receive the high-level voltage through the second transistor and output a high-level signal; wherein when the input signal is at a high level, the first transistor is turned on in response to the input signal, and the second transistor is configured to output a first on-current through the second connection terminal of the second transistor in response to a first control voltage received by the second control terminal, to cause the inverted-signal output terminal to output a low-level signal; and
wherein an on-impedance of the second transistor when the second transistor outputs the first on-current is higher than an on-impedance of the first transistor when the first transistor is turned on, and the first on-current output from the second transistor varies with the first control voltage.

18. The display device of claim 17, wherein the inverter circuit further comprises an adjusting sub-circuit, wherein the adjusting sub-circuit comprises a control terminal and a control-voltage output terminal, the control terminal of the adjusting sub-circuit is configured to receive the input signal, and the control-voltage output terminal of the adjusting sub-circuit is electrically connected to the second control terminal of the second transistor; and the adjusting sub-circuit is configured to output the first control voltage to the second control terminal of the second transistor in response to the input signal at the high level.

19. The display device of claim 18, wherein the adjusting sub-circuit comprises a third transistor, the third transistor comprises a control terminal, a first connection terminal, and a second connection terminal, the control terminal of the third transistor is the control terminal of the adjusting sub-circuit, the second connection terminal of the third transistor is configured to receive a second low-level voltage, and the first connection terminal of the third transistor is the control-voltage output terminal of the adjusting sub-circuit; the third transistor is turned off in response to the input signal at the low level, and is turned on in response to the input signal at the high level and is configured to output the first control voltage to the second control terminal of the second transistor through the first connection terminal of the third transistor; and the first control voltage is the second low-level voltage.

20. The display device of claim 19, wherein the first low-level voltage is equal to the second low-level voltage; the inverter circuit further comprises a first voltage terminal and a second voltage terminal; the first voltage terminal is electrically connected to both the first connection terminal and the first control terminal of the second transistor, and is configured to output the high-level voltage to the first connection terminal and the first control terminal of the second transistor; the second voltage terminal is electrically connected to both the second connection terminal of the first transistor and the second connection terminal of the third transistor, and is configured to output the first low-level voltage to the second connection terminal of the first transistor and the second connection terminal of the third transistor.
